(19) United States
(12) Patent Application Publication
(10) Pub. No.: US 2013/0099505 A1
(43) Pub. Date: Apr. 25, 2013

(54) ELECTROMECHANICAL ATTACHMENT MECHANISM FOR GENERATOR HEAD

(71) Applicant: ROBERTO MONTES, HARLINGEN, TX (US)

(72) Inventor: ROBERTO MONTES, HARLINGEN, TX (US)

(21) Appl. No.: 13/342,043

(22) Filed: Jan. 1, 2012

Related U.S. Application Data
(60) Provisional application No. 61/429,217, filed on Jan. 3, 2011.

(51) Int. Cl. H02K 57/00

(52) U.S. Cl. CPC H02K 57/00
USPC 290/1 A

(57) ABSTRACT

A mechanism that uses several parts and components herein described, to rotate an alternator in order to produce electric power, while sustaining itself for long periods of time.

### CROSS-REFERENCE TO RELATED APPLICATIONS

This application claims priority, of a provisional application No. 61/429,217 filed on Jan. 3, 2011 at The United States Patent and Trademark Office.

### FIELD OF THE INVENTION

Not applicable.

### BACKGROUND OF THE INVENTION

Not applicable.

### BRIEF SUMMARY OF THE INVENTION

The object and purpose of this invention is to produce electrical energy, it uses a method in which a set of gears with an oval frame, produces an elliptical movement on a shaft creating an angular movement of a body attached to it, then turning an alternator which powers a voltage inverter while maintaining a battery. This mechanism, sustains itself, powers an inverter, and maintains a battery while using any left power to provide electricity to other devices through the inverter. It also features an option to save power, this feature comprises an oval frame with racks at both ends that are pushed or pulled by a motor with the help of a commutator that turns the motor on or off at the right moment of the cycle.

### BRIEF DESCRIPTION OF THE SEVERAL VIEWS OF THE DRAWINGS

FIG. 1 shows a rectangular frame used to hold the several parts of this mechanism.

FIG. 2 shows a set of gears with an oval frame.

FIG. 3 shows a shaft with a spherical lightly heavy body attached perpendicular to the shaft.

FIG. 4 shows an oval frame with racks at both ends and the gear that pushes or pulls this oval.

FIG. 5 shows an arrangement of the parts of this mechanism.

FIG. 6 shows how the main parts of this mechanism are placed in the frame shown in FIG. 1. FIG. 7 shows two mechanisms working as one in order to minimize vibration and to double the power output.

### DETAIL DESCRIPTION

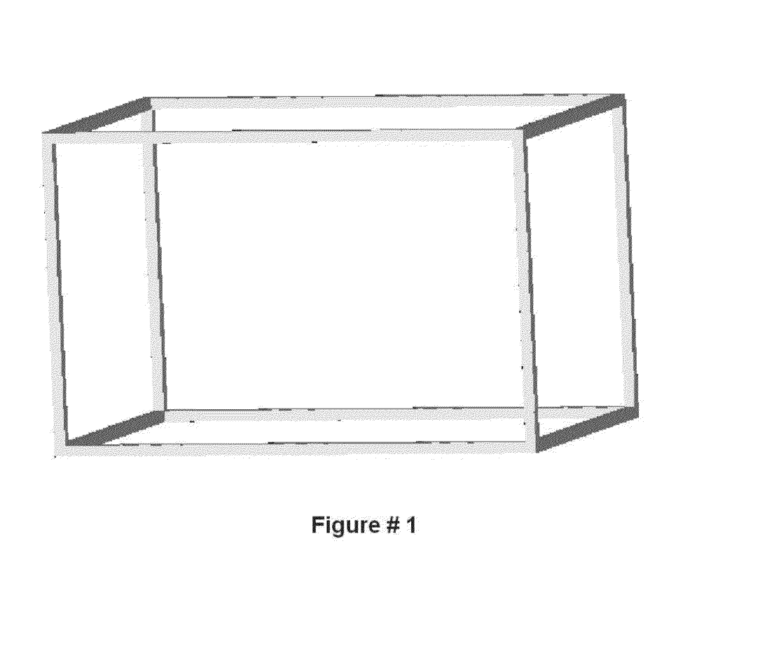

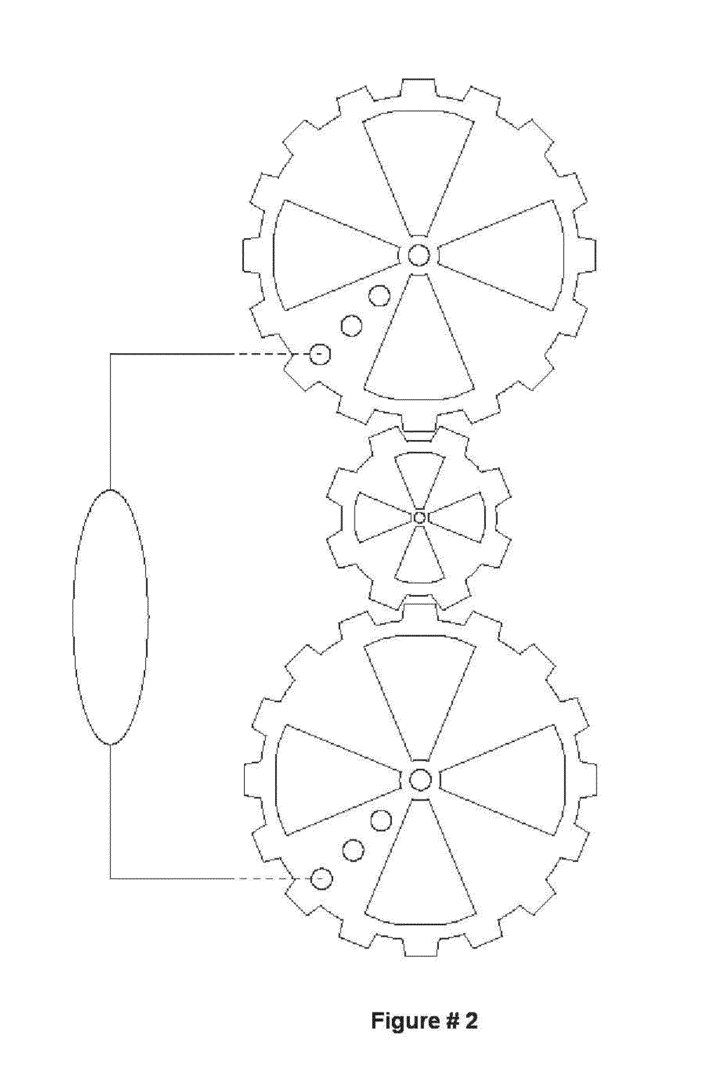

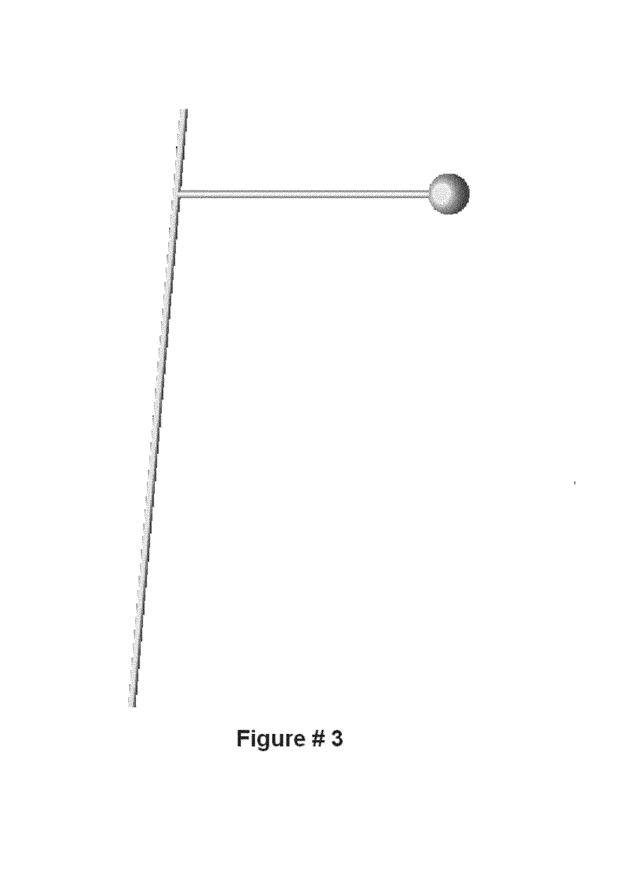

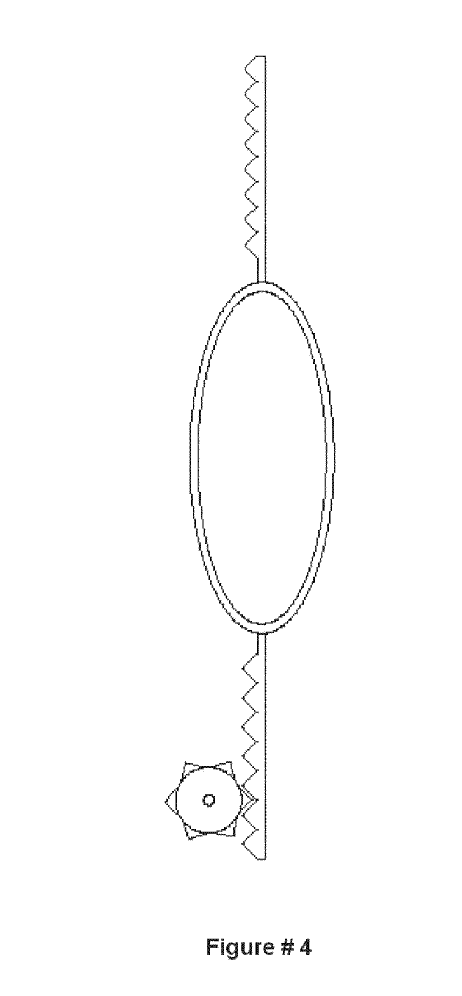

This mechanism comprises a rectangular metal frame as shown in FIG. 1. A set of gears with an oval frame attached to these through bearings as shown in FIG. 2. A shaft with a weight attached perpendicular to it as shown in FIG. 3. A constant velocity joint a one way bearing a coupling a chain or belt a commutator and two motors. The way this mechanism works is that when one of the motors turns the gears, the oval frame attached to these produces a movement in the form of an ellipse in the upper end of the shaft, creating an angular movement on the body of weight attached to the shaft shown in FIG. 3, consequently rotating a generator head through a constant velocity joint a coupling and a one way bearing.

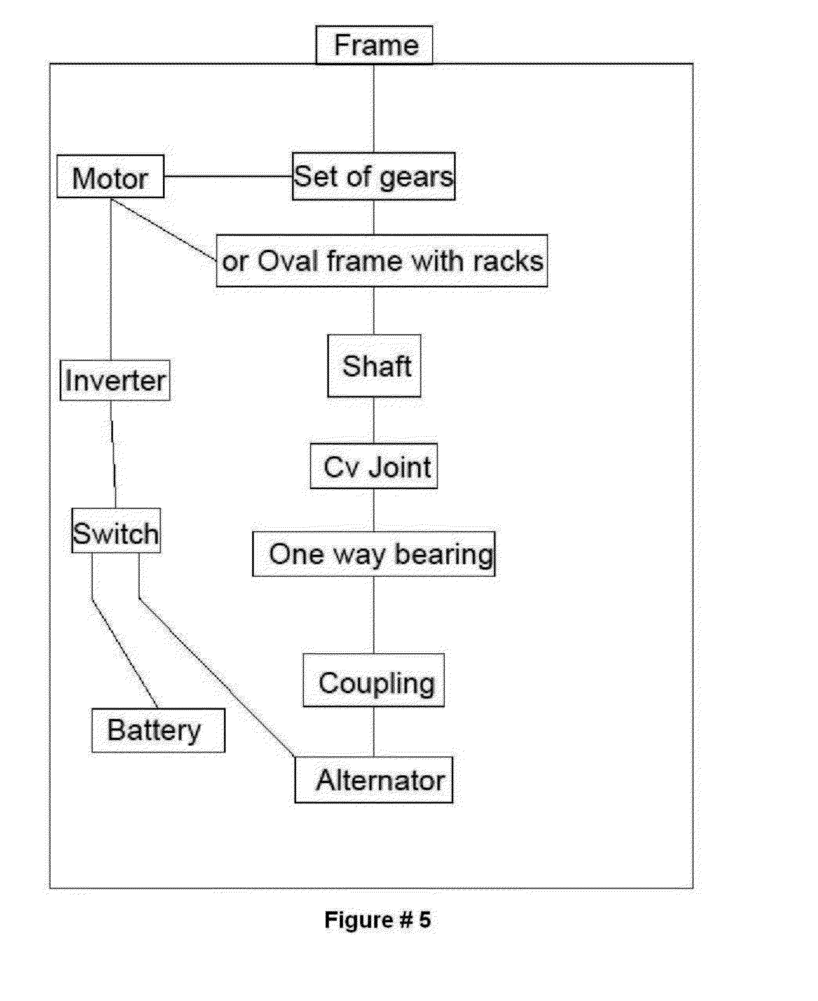

This mechanism also features an oval frame like the one attached to the gears, in this case the oval has two racks at both ends as shown in FIG. 4 so that a motor can pull or push on the racks, with the help of a commutator with the purpose of saving energy as the use of power by the motor would be intermittent also the commutator turns on and off the motor at the right time of the cycle.

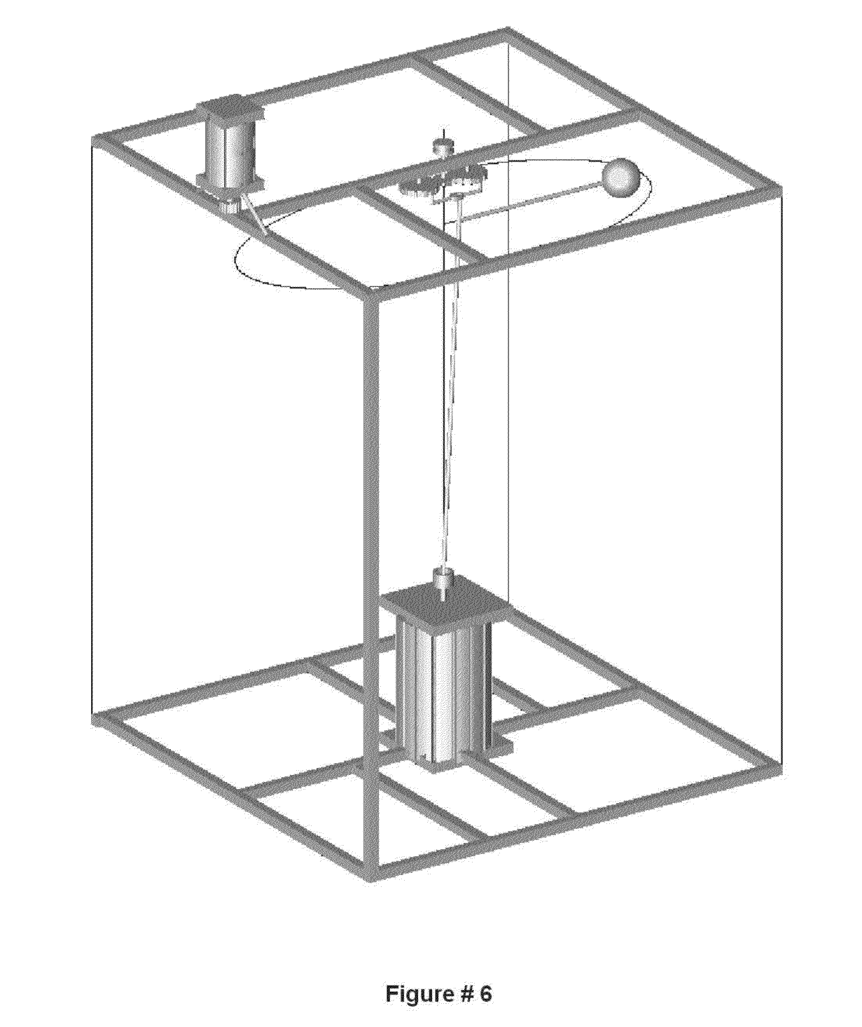

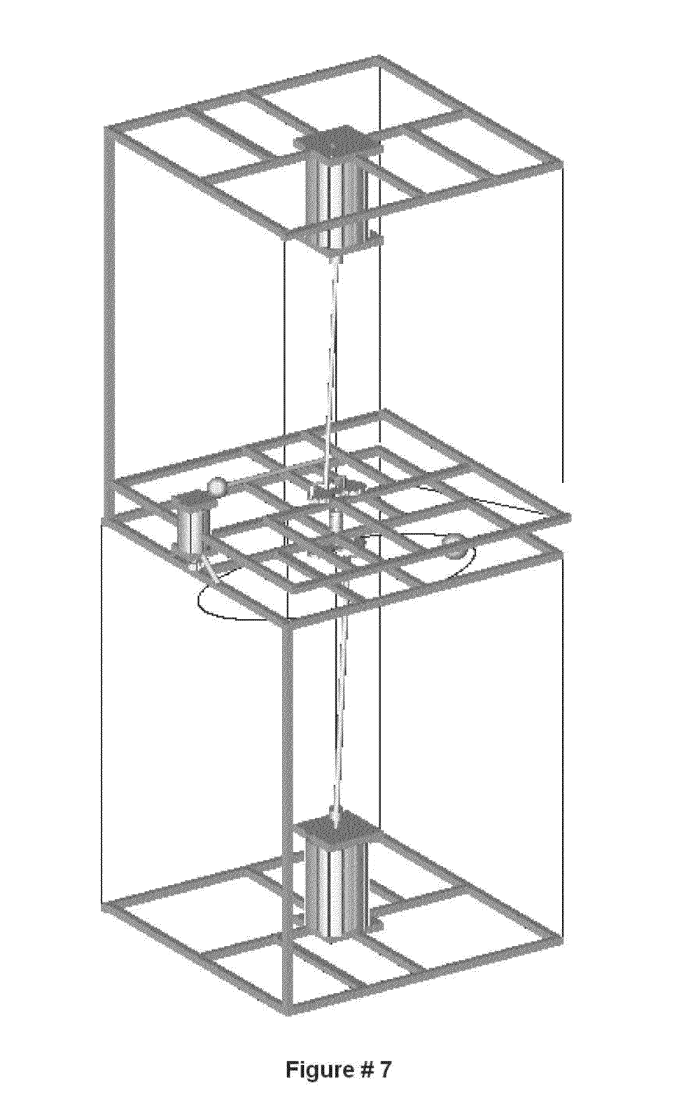

The best way contemplated by the inventor of using this invention, is that the mechanism be used in connection with a battery, an alternator and a power inverter, so when the system starts on battery power and the generator starts producing its power of 12 volts, through a switch, it starts powering the inverter and the inverter ceases relaying on the battery power, by then the system is producing power enough for the motor and any other electric device, also power to charge the battery. FIG. 5 shows the arrangement of parts of this mechanism. FIG. 6 and FIG. 7 shows this mechanism main parts assembled.

1. The inventor claims as his invention the method, manner and process of generating electricity through this mechanism, arrangement of parts and the mechanism herein described, capable of generating an elliptical movement on a shaft in order to rotate an alternator to produce electric energy.
